(19) United States
(12) Patent Application Publication
(10) Pub. No.: US 2019/0138293 A1
(43) Pub. Date: May 9, 2019

(54) PATTERN RECOGNITION PLATFORM

(71) Applicant: Venuetize LLC, Tampa, FL (US)

(72) Inventor: Nimish Shrivastava, San Marcos, CA (US)

(21) Appl. No.: 16/186,431

(22) Filed: Nov. 9, 2018

Related U.S. Application Data
(60) Provisional application No. 62/584,079, filed on Nov. 9, 2017.

(51) Int. Cl. G06F 8/65; H04L 29/08

(52) U.S. Cl. CPC G06F 8/65; H04L 67/34

(57) ABSTRACT

System, method, and a computer program providing applications to a client device based on pattern matching. A pattern that includes multiple parameters is received from a client device. Patterns that are associated with multiple applications that execute on a platform are retrieved. A match between the pattern received from the client device and a pattern associated with an application that executes on a platform is determined. An application package that includes instructions associated with the application that executes on the platform is generated and provided to the client device. The instructions in the application package manipulate an application that executes on the client device according to the application that executes on the platform.

### PRIORITY APPLICATION DATA

This application claims priority to U.S. Provisional Patent Application No. 62/584,079 filed on Nov. 9, 2017, which is incorporated by reference in its entirety.

### TECHNICAL FIELD

The disclosure generally relates to computerized platforms, and specifically to using pattern recognition to provide applications and actions to a client device.

### BACKGROUND

Conventional computing platforms provide a set of applications to all users. For example, users using computing devices may access a platform interface, and use the interface to upload data to the platform, make the data available to other users, and retrieve, manipulate, and display data. Such platforms however, do not provide users with applications that are tailored to the users based parameters that change with the environment and user information. Accordingly, what is needed are systems and methods that dynamically provide applications that are tailored to the users based various patterns.

### SUMMARY OF THE DISCLOSURE

Embodiments describe a system, method, and computer program product for customizing content. A pattern with a plurality of parameters is received from a client device. A plurality of patterns associated with a plurality of applications are retrieved. A match between the plurality of parameters in the pattern received from the client device and a pattern from the plurality of patterns is determined. A first application that is associated with the matched pattern is determined. An application package that includes instructions for manipulating an application executing on the client device using the first application is generated. The package is provided to the client devices, wherein the instructions in the application package manipulate the application executing on the client device.

Embodiments also describe a system, method, and computer program product for receiving a second pattern from the client device within a preconfigured time interval from the pattern received from the client device, determining a match between the second pattern and a second pattern in the plurality of patterns, determining that the first application in the plurality of applications is associated with the second pattern in the plurality of patterns, generating a second application package that includes instructions for manipulating the application executing on the client device according to the first application, and providing the second application package to the client device, wherein instructions in the second application package manipulate the application executing on the client device.

Embodiments also describe a system, method, and computer program product for receiving a second pattern from the client device that is different from the first pattern, determining a match between the second pattern and a second pattern in the plurality of patterns, determining that a second application in the plurality of applications is associated with the second pattern in the plurality of patterns, generating a second application package that includes instructions for manipulating the application executing on the client device according to the second application, and providing the application package to the client device, wherein instructions in the second application package manipulate the application executing on the client device.

Embodiments also describe a system, method, and computer program product wherein a first pattern includes a first parameter associated with a location of the client device and a second parameter that is associated with user information.

Embodiments also describe a system, method, and computer program product wherein a first pattern includes a first parameter associated with a user information and a second pattern is associated with the weather.

Embodiments also describe a system, method, and computer program product for generating a second application package that includes instructions for manipulating a second application executing on a second client device using the first application from the plurality of applications executing on the platform, and providing the second application package to a second client device, wherein instructions in the second application package manipulate an application executing on the second client device.

Embodiments also describe a system, method, and computer program product wherein instructions in the application package include a service that executes on the application executing on the client device.

Embodiments also describe a system, method, and computer program product for providing a first parameter and a second parameter, generating a second pattern in the plurality of patterns using the first parameter and the second parameter, wherein the generating identifies a range of values that includes a value in the first parameter, and associating the second pattern in the plurality of patterns with a second application in the plurality of applications.

### BRIEF DESCRIPTION OF THE DRAWINGS

FIG. 1 is a block diagram of a system environment where embodiments can be implemented.

FIG. 2 is a block diagram of a platform, according to an embodiment.

FIG. 3 is a diagram illustrating patterns that may be generated using a location estimate of a client device, according to an embodiment.

FIG. 4 is a block diagram of an example platform, according to an embodiment.

FIG. 5 is a flowchart of a method for using patterns to provide applications to a client device, according to an embodiment.

FIG. 6 is a flowchart of a method for configuring a pattern for an application, according to an embodiment.

FIG. 7 is a block diagram of a computer system suitable for implementing one or more components in FIGS. 1-6, according to an embodiment.

Embodiments of the disclosure and their advantages as depicted by the figures described above are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

The detailed description set forth below, in connection with the appended drawings, is intended as a description of various configurations and is not intended to represent the only configurations in which the concepts described herein may be practiced. The detailed description includes specific details for providing a thorough understanding of the various concepts. However, it will be apparent to those skilled in the art that these concepts may be practiced without these specific details. In some instances, well-known structures and components are shown in block diagram form in order to avoid obscuring such concepts.

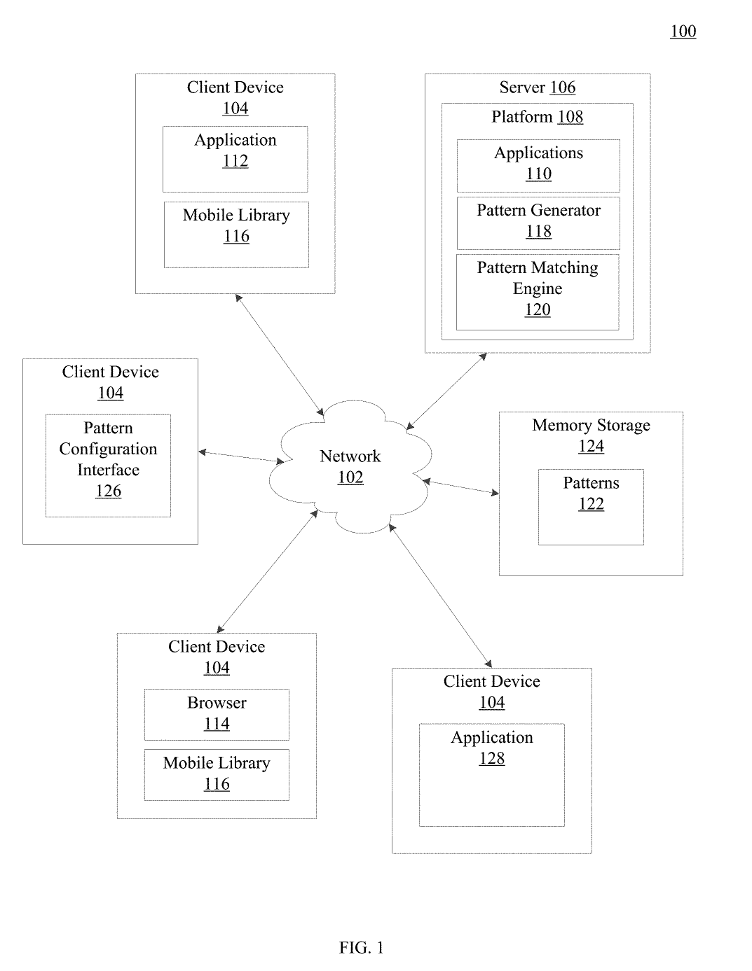

FIG. 1 is an example system 100 where embodiments can be implemented. System 100 includes a network 102. Network 102 may be implemented as a single network or a combination of multiple networks, including local area networks (LANs), wide area networks (WANs) such as the Internet or the Word Wide Web, metropolitan area networks (MANs), etc. Network 102 may also include one or more of intranets, landline networks, wireless networks, and/or other appropriate types of networks.

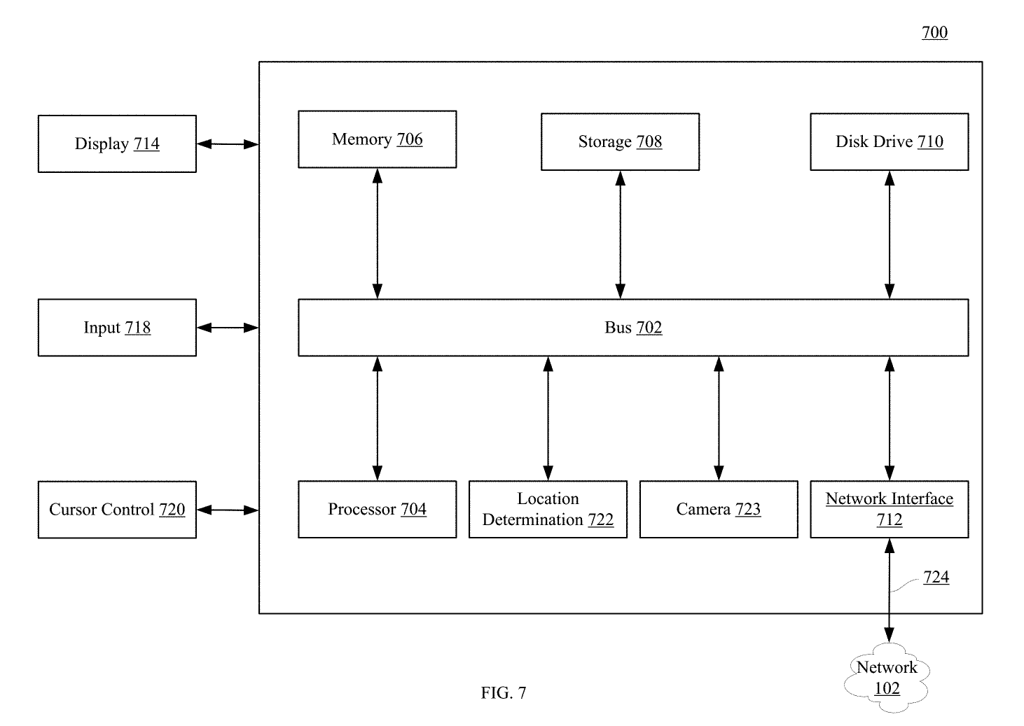

Example system 100 includes one or more client devices 104. Client device 104 may be a portable or non-portable electronic device under control of a user, and configured to transmit, receive, and manipulate data over network 102. Example client device 104 may include a smartphone, a tablet, a laptop computer, a wearable electronic device, eyeglasses that can be incorporated into an electronic device, an electronic watch, etc. Client device 104 may also include and execute operating systems, such as iOS, Android, Unix, Linux, Microsoft Windows, etc. In an embodiment, one or more components that may be included in client device 104 are described in detail in FIG. 7.

In an embodiment, system 100 includes a server 106. Server 106 may be an application server, a web server, a cloud server, etc., that provides data and information to client device 104. In an embodiment, server 106 may store data, applications, instructions, etc. Server 106 may also provide data, applications, instructions, etc., to client device 104. In an embodiment, one or more components that may be included in server 106 are described in detail in FIG. 7.

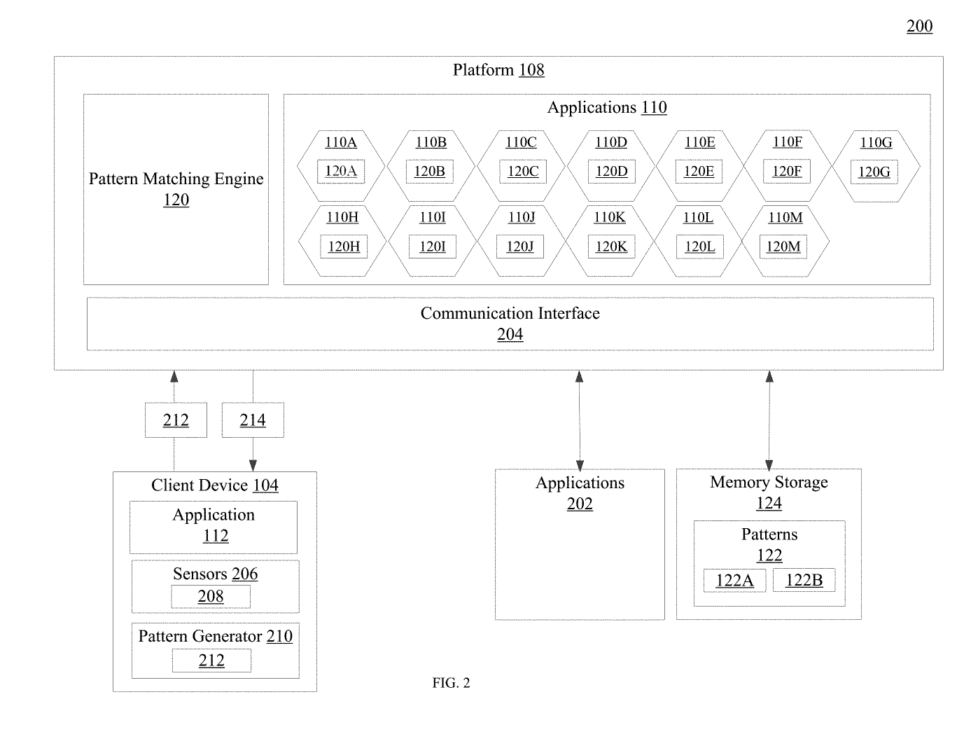

In an embodiment, server 106 may host a platform 108. Platform 108 may be a collection of one or more applications 110 that provide one or more products or services that may be accessed to by platform 108 or execute within platform 108. Various applications are discussed with reference to FIG. 2 below. In some embodiments, platform 108 may provide user specific applications, engagements, and services.

In some embodiments, system 100 may include one or more applications 112. Application 112 may be a software application designed using software development kit (“SDK”), Java, C++, Objective C, Swift, Kotlin, JavaScript, Python, CSS, PHP, Rube, etc., or any combination thereof. In some embodiments, application 112 may be downloaded to client device 104 from server 106, pre-installed on client device 104, installed on the client device 104 using portable memory storage devices, such as compact disks or a thumb-drives, etc. Once installed, application 112 may execute on client device 104 and communicate with platform 108. The communication may retrieve data and services provided by applications 110 executing on platform 108 for display on application 112, upload data to applications 110 and/or platform 108, etc. In some embodiments, the communication may use a Hypertext Transfer Protocol (“HTTP”) or JavaScript Object Notation (“JSON”) format and protocol.

In some embodiments, client device 104 may also include a browser 114. Browser 114 is an application executing on client device 104 that retrieves and presents information resources that are stored on server 106 connected to the Internet or the World Wide Web. An information resource may be identified by a uniform resource identifier (URI) or a uniform resource locator (URL) and may be a webpage, an image, a video, or another type of content. In some embodiments, information may be downloaded from platform 108 and displayed on client device 104. In other words, browser 114 may also be used to display data and manipulate data instead of application 110.

In an embodiment, a mobile library 116 may also be downloaded or otherwise installed on client device 104. Mobile library 116 may store instructions and information that may be used by application 112 or browser 114. Mobile library 116 may also store parameters associated with client device 104. These parameters may be used by application 112 or browser 114 and be uploaded to platform 108 individually to in a pattern that includes multiple parameters. Example parameters may include the location of client device 104 or information associated with the location of client device 104, such as weather, a number of other client devices 104 at a location, a number of people that are present within a configurable distance of client device 104, etc. Example parameters may also include user information, such as user age, gender, date of birth, city of residence, country of residence, user browsing history, user purchase history, etc. Example parameters may also include applications that are stored or downloaded onto client device, and dates and times that the user has been using client device 104. Example parameters may also include a type of client device 104, the operating system that executes on client device 104, etc.

In an embodiment, mobile library 116 may communicate with platform 108. The communications may provide platform 108 with parameters that mobile library 116 obtained from client device 104.

In an embodiment, platform 108 may include a pattern generator 118 and a pattern matching engine 120. Although pattern generator 118 and pattern matching engine 120 are illustrated as single components in FIG. 1, pattern generator 118 and pattern matching engine 120 may be included in each application 110 that executes within platform 108.

In an embodiment, pattern generator 118 may generate one or more patterns 122 and associate the generated patterns with one or more applications 110. Each pattern 122 may include a value or a value range that maps to one or more parameters described above, and may be used to validate the one or more parameters. Alternatively, each pattern 122 may include one or more rules that may be validated using values or a range of values in the one or more parameters.

In an embodiment, pattern 122 may be a structure written in a programming language such as”), Java, C++, Objective C, Swift, Kotlin, JavaScript, Python, CSS, PHP, Rube, etc., and may have various forms, such as a pattern string, a binary structure, etc.

In an embodiment, pattern generator 118 may receive configuration instructions from a pattern configuration interface 126. The instructions may cause pattern generator 118 to generate patterns 122, associate patterns 122 with applications 110, and cause applications 110 to issue actions, provide data, and/or services to application 112 when patterns match the parameters provided from client device 104, as will be discussed below. Pattern configuration interface 126 may execute on client device 104, that may be the same or different client device 104 that includes application 112. In an embodiment, pattern configuration interface 126 may receive configuration instructions, from a user, such as a venue owner in some embodiments that provides applications 110 included in platform 108 to the users using client devices 104. Example instructions may be instructions that configure parameters included in patterns 122, and configure values or a range of values of the parameters in patterns 122 that qualify as a match to the parameters provided from client device 104. Example instructions may also generate one or more rules in patterns 122 that may tested the values in one or more parameters received from client device 104. Example instructions may also map applications 110, actions that may be generated by applications 110, or services that may be provided by applications 110 to application 112.

In an embodiment, pattern generator 118 may use the instructions from pattern configuration interface 126 to associate each pattern 122 with applications 110, an action that may be provided by application 110 to application 112, a service provided by applications 110, etc. In this way, when pattern matching engine 120 identifies a match between the parameters from client device 104 and patterns 122, platform 108 may provide application 110, an action generated by application 110, and/or service provided by application 110 to application 112.

In an embodiment, platform 108 may store patterns 122 in memory storage 124. Memory storage 124 may be internal or external to server 106. In some embodiments, memory storage 124 may be a pattern database configured to store organized data in memory storage, such as one of memories described in detail in FIG. 7 that is accessible to platform 108.

As discussed above, platform 108 may include a pattern matching engine 120. Pattern matching engine 120 may match one or more parameters that platform 108 may receive from client devices 104 or that are included in platform 108 to patterns 122. To identify a match between the parameters and patterns 122, pattern matching engine 120 may determine if parameters match to the parameters included in pattern 122 or that the values of the parameters match the value range of the corresponding parameters in pattern 122. In another embodiment, pattern matching engine 120 may use the one or more parameters to validate the rules in pattern 122.

When pattern matching engine 120 matches or validates the parameters to pattern 122, pattern matching engine 120 may invoke actions or services from applications 110 that are associated with the matched or a validated pattern 122. Example actions or services may include providing one of applications 110 to execute within application 112, providing data or service associated with application 110 to application 112, and/or providing a notification from application 110 to application 112.

In an embodiment, system 100 may also include application 218. Application 128 may execute on a client device 104 that is separate from client device 104 that includes application 112 but that may be in a vicinity of client device 104 that executes application 112 or communicatively coupled to application 112. In an embodiment, when pattern matching engine 120 matches or validates the parameters to pattern 122, example actions or services may include providing one of applications 110 to execute within application 128, providing data or service associated with application 110 to application 128, and/or providing a notification from application 110 to application 128.

In an embodiment, client device 104 may continuously transmit parameters to platform 108. Continuously may mean at preconfigured time intervals, whenever one or more parameters changes, or when user is logged into application 112 and application 112 receives instructions via a user interface. In this way, application 112 may receive various applications 110, actions and/or services associated with applications 110 based on the updated parameters stored in or collected on client device 104.

FIG. 2 is a block diagram 200 of an example platform 108, according to some embodiments. As discussed above, platform 108 may be a mobile engagement platform that may be tailored by a venue provider to provide a personalize experience to a user using application 112. To provide a personalized experience, a venue provider may configure platform 108 to provide applications 110, actions and/or services associated with applications 110 to application 112 or another application, such as application 128 (not shown) based on a match between parameters received from client device 104 and patterns 122. Because each venue provider may configure different patterns 122 and associate patterns 122 with different applications, actions, and/or services, platform 108 may behave differently for different venue providers. Example venue providers may be sports venue providers, theater providers, shopping center providers, etc.

As discussed above, platform 108 may include one or more applications 110. Example applications may be applications 110A-110M. Applications 110A-110M may be software programs or modules that may execute within platform 108 or be accessed by platform 108. Each applications 110A-110M may be configured to provide different types of products, services, notifications, interfaces, etc., to application 112 or generate an action for application 112 or application 128 (not shown).

Example applications 110A-110M that may be specific to platform 108 that is a venue platform are discussed below. However, a person of ordinary skill in the art may appreciate that applications or modules that are not specifically described herein may also be added to platform 108.

An example application 110A may be an identity management application that may store and manage user sign on information. Example information may be user credentials, such as the name and password of a user trying to access application 112, user login/logout history, etc.

In another example, application 110B may be a mobile commerce application. The mobile commerce application may provide application 112 with an interface for purchasing goods and services. When pattern matching engine 120 matches parameters to pattern 122, the mobile commerce application may provide advertisements for products or services to application 112 in one embodiment. In another embodiment, mobile commerce application may provide an interface to application 112 that may be used to interface with multiple vendors, kiosks, etc., that are proximate to client device 104, such as within 20 feet from client device 104, 50 feet from client device 104, etc.

In another example, application 110C may be a notifications application. The notification application may provide notifications to application 112 and may interact with other applications 110 included in platform 108 to provide the notifications. Example notifications may be advertisements, news, sales for good or services at a venue, etc. Other notifications may be future performances that are either in the same venue as the location of client device 104 or similar to performances that may have been previously purchased using application 112. In another example, the notification application may provide an advertisement to application 128 that is in proximity of client device 104 (not shown). In an embodiment, the notification application may provide a notification when the parameters from client device 104 match pattern(s) 122.

In another example, application 110D may be a safety and security application. Safety and security application may be related to an incident management system and provides security to platform 108, application 112, and users using application 112. For example, safety and security application may generate notifications that may indicate safety and security at a venue that utilizes platform 108. For instance, safety and security application may identify an external safety hazard, such as a fire, at a venue, that may occur where client device 104 that executes application 112 is located. In this case, when pattern matching engine 120 matches the parameters that correspond to a fire to pattern 122, the safety and security application may cause the map application discussed below to provide a map of the venue to application 112, or to provide a notification of the fire to one or more client devices 104 that the proximity application identified as being in a configurable distance of the venue.

In another example, application 110E may be a data analytics application. The data analytics application may use data analytics to predict user preferences based on the previous user input into application 112, previous purchase history, etc. In an embodiment, the data analytics application may include a neural network that may be trained on user preferences of multiple users using application 112 to provide recommendations to a user using application 112. In an embodiment, the data analytics application may issue a notification, an advertisement, or provide an interface from another application 110 for display in application 112 based on the match between the parameters and pattern 122.

In yet another example, application 110F may be a search application. The search application may perform a search across other applications 110 and may provide key words, expressions, and links to different queries entered from application 112. In another example, search application may also be utilized by pattern matching engine 120 to determine services or notifications that may be provided to application 112 in response to a match between the parameters and patterns 122.

In yet another example, application 110G may be a profile application. The profile application may store information associated with profiles of users using application 112. The profile application may also store properties, such as a user name, address, telephone number, gender, age, gender, etc., of a user that may be used to accesses platform 108 via application 112 or browser 114, etc. The profile application may also store products and services that have been previously purchased by a user using application 112, user transaction history, interests, favorite stores, etc. With respect to the ticket related venues, the profiles application may track whether a user using application 112 is a season ticket holder, single ticket buyer, suite owner, etc. In an embodiment, the profile application may, in addition to client device 104, also provide parameters that pattern matching engine 120 may match with patterns 122. Based on the match, the mobile commerce application or another application may provide actions or services to application 112.

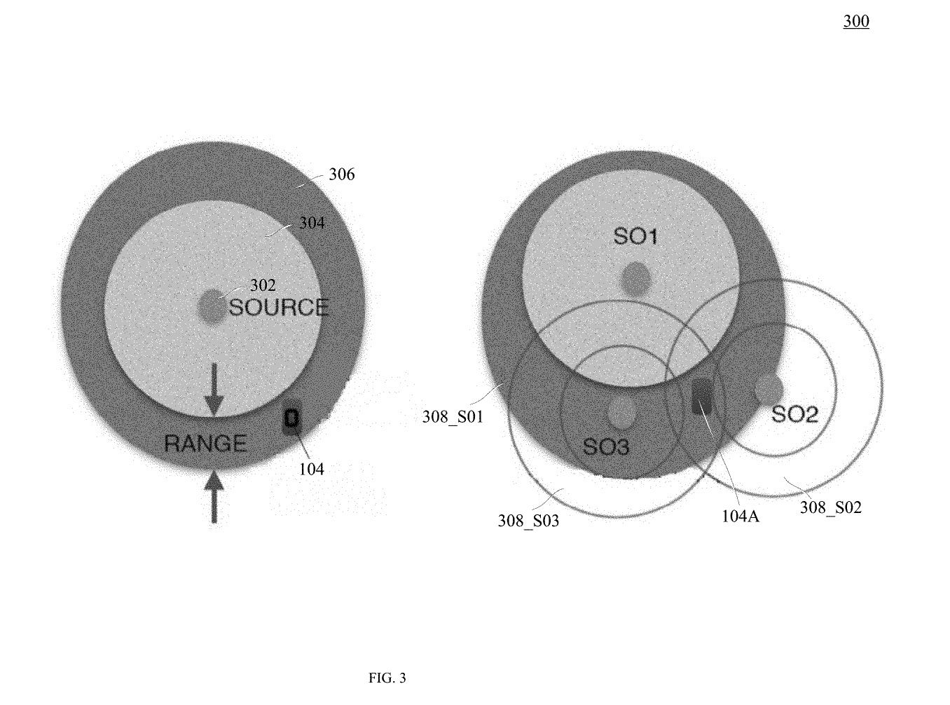

In yet another example, application 110H may be a proximity application. A proximity application may determine location of client device 104 based on the strengths of signals received at client device 104 from signal sources, such as beacons, Wi-Fi hot spots, as further discussed in part in FIG. 3. Additionally, based on the location of client device or the match between the parameters that include the location and pattern(s) 120, the proximity application may provide various actions or services to client device 104.

In yet another example, application 110I may be a map application. A map application may store outdoor maps, indoor maps, such as maps of various outdoor and indoor venues, user location coordinates, etc. In an embodiment, based on the match between the parameters that may include location parameters, signal strength parameters, user information parameters, etc., and pattern 122, the map application may provide different maps to application 112. For example, suppose the location parameters indicate that client device 104 that executes application 112 is at a venue. In response to the match, the map application may provide application 112 with access to the map of the venue.

In yet another example, application 110J may be a transportation application. A transportation application may provide real-time traffic updates, live maps, driving directions, voice commands, live web camera views, etc. In an embodiment, transportation application may also be used to order pick-up and drop-off services from application 112. In an embodiment, based on the match between pattern 122 and for example, the location parameters and the user information parameters, the transportation application may provide application 112 with traffic updates, live web camera views, etc.

In yet another example, application 110K may be a parking application. A parking application may display and manage digital parking passes and facilitate parking purchases using application 112. In an embodiment, based on a match between pattern 122 and for example, the location parameters and the user behavior parameters, the parking application may provide application 112 with parking coupons, purchased digital parking passes, etc. In another example, parking application may determine, using user information and location parameters that client device 104 is located in an area of the venue and the user of client device 104 that executes application 112 is a season ticket holder. In this case, the parking application may transmit a notification to application 112 that indicates a parking area that has been set apart and designated for the season ticket holders, a map of the parking area, and/or directions to the entrance of the parking area.

In yet another example, application 110L may be a ticketing application. The ticketing application may provide digital tickets for display on client device 104, provide a medium for selling and/or trading tickets, provide a listing of upcoming events, provide an option to upgrade tickets. In some embodiments, application 110L may also have an interface with a wallet application and applications 202 that are external to platform 108 and are discussed below. In an embodiment, based on a match between pattern 122 and for example, the location parameters and the user behavior parameters, ticketing application may provide application 112 with digital tickets, offers for ticket sales, options to upgrade a ticket once the ticketing application detects that client device 104 is at a venue that is associated with the ticket, etc.

In yet another example, application 110M may be a mobile wallet application. The mobile wallet application may perform transactions using cashless payment tokens. In an embodiment, based on a match between pattern 122 and for example, the location parameters and the user information, or other parameters, the mobile wallet application may provide application 112 with interfaces, discounts, etc., that are associated with venue or vendors near client device 104.

In an embodiment, platform 108 may also interface with applications 202. Applications 202 may be application generated by third party providers and execute externally to platform 108. Applications 202 may provide products or services to platform 108 and or application 112. Example application 202 may include ticketing applications, finance applications, payment gateways, loyalty applications, and content applications. In an embodiment, platform 108 may communicate with applications 202 using a communication interface 204.

In an embodiment, applications 202 may execute on the same or different server as server 106 of FIG. 1 that hosts platform 108.

In an embodiment, platform 108 may include communication interface 204. Communication interface 204 may transmit and receive requests and responses between client devices 104, platform 108, and applications 202. In an embodiment, communication interface 204 may include an application interface layer that manages communications across application 112, platform 108, client devices 104, etc. In a non-limiting embodiment, communication interface 204 may communicate with applications 112 using the HyperText Transfer Protocol (“HTTP”) Web Sockets.

In an embodiment, client device 104 may include one or more sensors 206. Sensors 206 may obtain or monitor parameter(s) 208 by sensing information, such as signal strength or weather, monitor user input to application 112, and user interaction with client device 104. Example parameters 208 may be the parameters discussed above.

In an embodiment, sensor 206 may be a location system included in client device 104, such as a location system that determines location of client device 104 using global positioning satellite(s), triangulation techniques, radio wave techniques such as Bluetooth® or Wi-Fi, etc. When sensor 206 is a location system, parameters 208 may include a location of client device 104 in the latitude and longitude format, or signal strength format when the location system may identify the location of client device 104 with respect to one or more signal sources.

In another embodiment, sensor 206 may be a monitoring application. In this case, sensor 206 may monitor dates and times that application 112 and/or client device 104 is in an active mode and receives input from a user. In another embodiment, sensor 206 may monitor weather. When sensor 206 monitors weather, parameters 208 may include Fahrenheit or Celsius measurements. Another example sensor 206 may monitor user information. For example, sensor 206 may be an application or a module that executes within client device 104 and that may monitor user information, such as user age, gender, address, date of birth, city, country, etc., that client device 104 receives from the user input. When sensor 206 may receive user information, sensor 206 may include user information in parameters 208. In another example, sensor 206 may monitor user behavior. Example user behavior may include products and/or services that a user accessed using application 112, browsing history of application 112, etc. When sensor 206 monitors user behavior, sensor 206 may include user behavior in parameters 208. In an embodiment, sensor 206 may monitor credentials of a user using application 112 with respect to platform 108. When sensor 206 monitors credentials of a user with respect to platform 108, parameters 208 may include the credentials.

In an embodiment, parameters 208 may correspond to the spheres of influence on a user interacting with application 112. Based on these spheres, platform 108 may provide application 112 with applications 110A-110M, services, actions, and/or engagements provided by applications 110A-110M, etc., that may engage the user according to the spheres of influence associated with parameters 208. Some exemplary actions, services, etc., were discussed above.

In another embodiment, instead of sending parameters to platform 108, client device 104 may include a pattern generator 210. Pattern generator 210 may generate patterns 212 from parameters 208 determined using sensors 206.

FIG. 3 is a diagram 300 illustrating patterns that may be generated using a location estimate, according to an embodiment. FIG. 3 illustrates a signal source 302 generated by, for example, a BlueTooth® beacon. FIG. 3 also illustrates how the strength of a signal from signal source 302 may be viewed as concentric spheres 304A and 304B that surround signal source 302. Although spheres 304A and 304B are illustrated in FIG. 3, the implementation is not limited to this embodiment as multiple numbers of spheres may be used. The non-over lapping band between spheres 304A and 304B is range 308. Range 308 may be a distance measurement in meters or feet in some embodiments and may be parameter 208. For example, range 308 between spheres 304A and 304B may be 10 to 20 feet. In another example, range 308 may include an indicator that indicates that the distance is a short distance (S), a medium distance (M), or a long distance (L) with respect to signal source 302, as will be discussed further below.

In an embodiment, sensor 206 may map the distance measurements for various spheres to a strength of a signal from signal source 302. For example, sensor 206 may map range 308 to a strength of a signal from signal source 302 to client device 104 that is −70 dBm. In this case, when sensor 206 receives a signal with the signal strength of −70 dBm, sensor 206 may determine that client device 104 is within 10 feet to 20 feet from signal source 302. In an embodiment, pattern generator 118 may generate a pattern that indicates that client device is within range 308 of signal source 302. The pattern may be in a form or a string, binary structure or another software structure in some embodiments.

In an embodiment, FIG. 3 also illustrates how sensor 206 may receive signals from multiple signal sources 302, such as sources SO1, SO2, and SO3. In this case, client device 104A may be within ranges 308_SO1, 308_SO2, and 308_SO3 from the respective signal sources SO1, SO2, and SO3, where ranges 308_SO1, 308_SO2, and 308_SO3 are parameters 208. Once sensor 206 determines ranges 308_SO1, 308_SO2, and 308_SO3, sensor 206 may generate a pattern that indicates ranges 308_SO1, 308_SO2, and 308_SO3 from sources SO1, SO2, and SO3. As discussed above, range 308 may be designated as a short distance (S), a medium distance (M), or a long distance (L). With respect to FIG. 3, client device 104A may be in an L range of source SO1, an S range of source SO2 and an M range of source SO3. In some embodiments, pattern generator 210 may generate a pattern, such as a pattern string, for the above location of client device 104 with respect to signal sources SO1, SO2, and SO3:

SO1-L SO2-S SO3-M

Going back to FIG. 2, pattern generator 210 may also generate patterns 212 that include parameters 208, other than the range 308 discussed in FIG. 3. For example, pattern generator 210 may generate patterns 212 that are a combination of location information discussed in FIG. 3 and parameter 208 that is user information, such as age. Suppose, parameter 208 may indicate that a user is 25 years old. Pattern generator 210 may map the user's age to an individual value, such as 25, or to an age range such as 18-26. Once pattern generator 210 maps parameters 208 associated with user information and location, pattern generator 210 may generate a pattern, such as:

SO1-L SO2-S SO3-M AGE-18:26 Where the parameter AGE indicates the age range from 18 to 26. In another example, pattern generator 210 may also generate pattern 212 that includes another combination of parameters 208, such as the location discussed in FIG. 3, user information such as gender, and weather. Further, the weather parameter may have a value of 77° F. which pattern generator 210 may match to a range that is 75-79° F. In this case, for a user that pattern generator 210 identified as male, pattern generator 210 may generate pattern 212 that is:

SO1-L SO2-S SO3-M GENDER-M F-75:79.

A person of ordinary skill in the art will appreciate that pattern generator 210 discussed above may generate patterns 212 using different types of parameters 208 and is not limited to the examples discussed above. Further, pattern generator 210 may format patterns 212 using different indicators for the location, gender, age, etc., and may generate patterns 212 that are readable strings, software objects, include binary values, etc.

Once pattern generator 210 generates patterns 212, pattern generator 210 may cause client device 104 to transmit patterns 212 to platform 108. In an embodiment, pattern generator 210 may transmit patterns 212 to platform 108 at predefined time intervals, when pattern generator 210 determines a change has occurred in patterns 212 that were previously transmitted to platform 108 from client device, at the request of platform 108, etc.

As illustrated in FIG. 2, platform 108 may receive patterns 212 from client device 104. Once received, patterns matching engine 120 that executes on platform 108 may match patterns 212 received from client device 104, to various patterns 122 stored in memory storage 124. When pattern matching engine 120 identifies a match between pattern 212 and pattern 122 or pattern 212 and a portion of pattern 122, pattern matching engine 120 may identify one of applications 110A-110M or the services provided by the identified one of applications 110A-110M.

Once pattern matching engine 120 identifies one of applications 110A-110M or the services that correspond to one of applications 110A-110M, platform 108 may transmit the identified one of applications 110A-110M, a link to the one of the identified applications 110A-110M, the identified service and/or action to client device 104, collectively referred to as an identified application package 214, back client device 104. Application package 214 may include instructions that may cause the identified one of applications 110A-110M, a link to the one of the identified applications 110A-110M, the identified service and/or action to execute within application 112 executing on client device 104 or application 128 executing on a different client device 104.

In an embodiment, client device 104 receives application package 214. Once received, application 112 of client device 104 may use mobile library 116 (discussed in FIG. 1) to instantiate applications or services in application package 224 within client device 104 or within application 112. For example, suppose application package 214 includes application 110B. Once client device 104 receives application package 214, client device 104 may install and execute application 110B within application 112. In another example, application 112 may include a link that may be activated to access application 110B that executes on platform 108. In another example, client device 104 may install services included in application 110B or accessible via application 110B on client device 104. Example services may be an interface with a kiosk that is within a vicinity of client device 104, advertisements for products or services, an interface that may be used to purchase a product or service, etc. In another example, application 112 may display the action included in application package 214 such as displaying a notification from application 110B.

In another embodiment, client device 104 may install application 110B included in application package 214 on browser 114. In this case, browser 114 may access application 110B using a webpage and downloaded services provided by application 110B as tailored to pattern 212 to browser 114 (not shown).

Going back to platform 108, in an alternative embodiment, applications 110A-110M may include pattern matching engines 120A-120M. In this case, pattern matching engines 120A-120M may receive patterns 212 and match patterns 212 to patterns 122 associated with applications 110A-110M. Taking applications 110B and 110C as an example, suppose pattern matching engine 120A and pattern matching engine 120B receive pattern 212 from client device 104. Pattern matching engine 120A may retrieve patterns 122A from memory storage 124 that are associated with application 110B and pattern matching engine 120B may retrieve patterns 122 that are associated with application 112C. Notably, patterns 122A associated with application 110B and patterns 122B associated with application 110C may be the same, partially the same or different patterns 122.

In an embodiment, when pattern matching engine 120A identifies a match between patterns 212 and patterns 122A, pattern matching engine 120A may generate an application package 214 that includes application 110B, services provided by application 110B, and/or actions associated with application 110B. Once application 110B generates application package 214, communication interface 204 of platform 108 may transmit application package 214 to client device 104 to be processed as discussed above. Similar, when pattern matching engine 120B identifies a match between patterns 212 and patterns 122B, pattern matching engine 120B may generate an application package 214 that includes application 110C, services provided by application 110C, and/or data associated with application 110C. Once application 110C generates application package 214, communication interface 204 of platform 108 may transmit application package to client device 104 to be processed as discussed above. In some embodiments, application package 214 may include both applications 110B and 110C, while in other embodiments, communication interface 204 may transmit multiple application packages 214.

In an embodiment, platform 108 may also provide applications, services and/or data from applications 202 that are external to platform 108. For example, pattern matching engine 120 may receive patterns 212 and determine that patterns 212 match patterns 122 that are associated with applications 202. When a match is determined, pattern matching engine 120 may use communication interface 204 to request the matched applications 202, and/or services or actions that may be provided by the matched applications 202 to application 112. Once pattern matching engine 120 receives the matched applications 202, and/or services or data provided by the matched applications 202, pattern matching engine 120 generates application package 214 as discussed above and transmits application package 214 to client device 104.

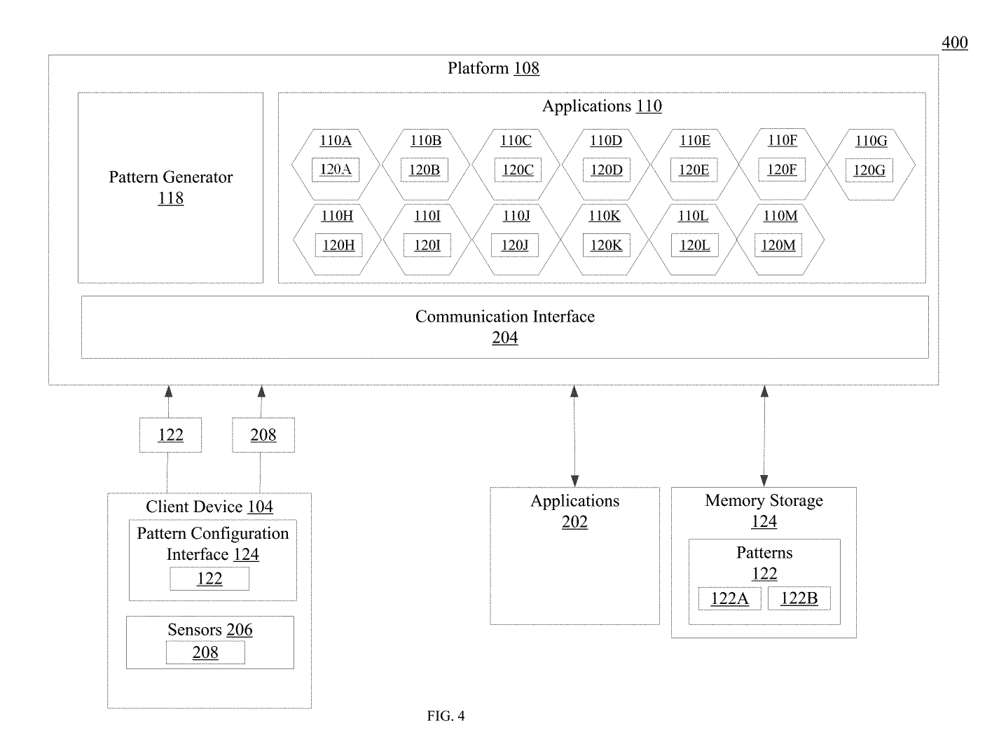

FIG. 4 is a block diagram 400 of an example platform 108, according to some embodiments. In FIG. 4, platform 108 may be configured using client device 104 that includes pattern configuration interface 126 that is described in FIG. 1. As discussed above, pattern configuration interface 126 may generate patterns 122 using one or more values in the same or different parameters 208. In another example, pattern configuration interface 126 may generate patterns 122 by determining rules that may be validated using the values in parameters 208. In yet another example, pattern configuration interface 126 may configure a value ranges that correspond to parameters 208.

In an embodiment, pattern configuration interface 126 may use sensors 206 to determine pattern 122 that corresponds to signal strength from signal sources 302 such as SO4, SO5, and SO6. For example, sensors 206 may receive signals from signal sources SO4, SO5, and SO6 and define pattern 122 that includes signal strength values from signal sources SO4, SO5, and SO6. Further, suppose client device 104 is located in front of a coffee shop in a mall when sensors 206 indicates pattern 122 that corresponds to signal strength as SO2-M SO4-L SO5-S SO6-L. Once sensor 206 determines pattern 122 that corresponds to the signal strength as related to signal sources SO2, SO4, SO5, and SO6 for the coffee shop location, pattern configuration interface 126 may transmit pattern 122 and the location to platform 108. In an alternative embodiment, sensors 206 may transmit parameters 208 that correspond to the signal strengths SO2-M SO4-L SO5-S SO6-L and the coffee shop location. In yet another embodiment, pattern configuration interface 216 may also transmit instructions that may indicate to pattern generator 118 to associate pattern 122 with applications 110A and 110B.

In an embodiment, once pattern generator 118 receives parameters 208 that map to pattern 122, and instructions to associate applications 110A and 110B with pattern 122, pattern generator 118 may generate pattern 122 and associate applications 110A and 110B with pattern 122. In another example, pattern generator 118 may receive pattern 122 when pattern 122 has been generated by pattern configuration interface 216. In this case, pattern generator 118 may associate pattern 122 with applications 110A and 110B. Once pattern generator 118 associated pattern 122 with applications 110A and 110B, pattern generator 118 may store pattern 122 and the corresponding associations in memory storage 124.

In an embodiment, platform 108 may store patterns 122 in memory storage 124.

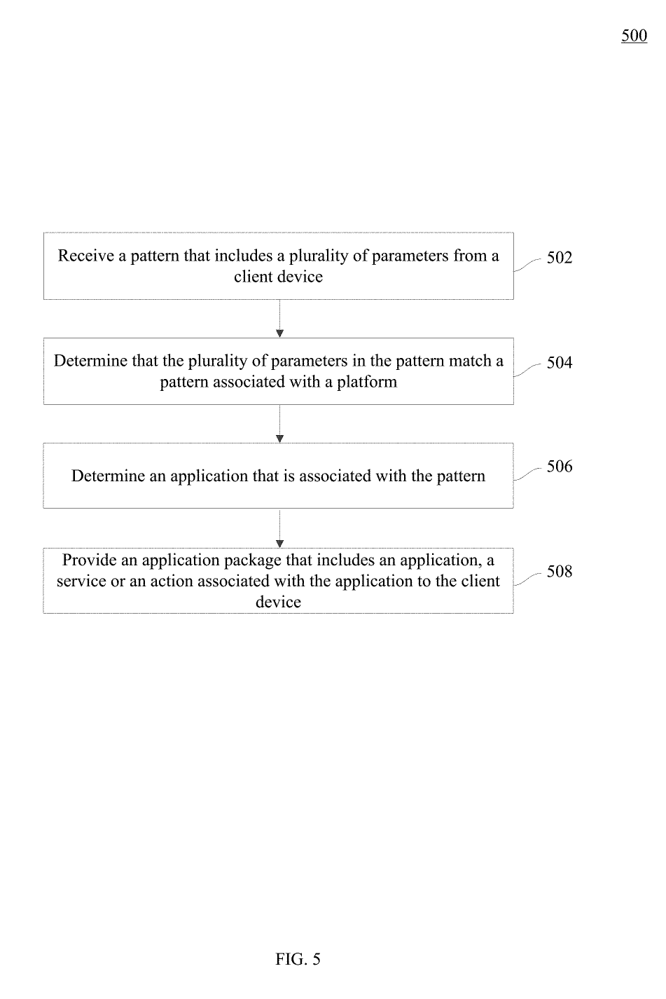

FIG. 5 is a flowchart of a method 500 for using patterns to provide applications to client device, according to an embodiment. Method 500 may be performed using hardware and/or software components described herein and in, e.g., FIGS. 1-3. Notably, one or more of the operations may be deleted, combined, or performed in a different order as appropriate. Further, additional operations may be performed at various stages of the method.

At operation 502, a pattern is received. For example, pattern matching engine 120 in platform 108 may receive pattern 212 that has been generated using sensors 206 of client device 104. As discussed above, pattern 212 may include multiple parameters 208 that may be associated with the location of client device 104, user information, date and time information, etc.

At operation 504, a match is determined. For example, pattern matching engine 120 may determine that values or a range of values of the parameters 208 in pattern 212 match the values or a range of values in patterns 122 stored in memory storage 125. In another example, pattern matching engine 120 may determine whether the values or a range of values in parameters 208 in pattern 212 pass the rules included in pattern 122.

At operation 506, an application is determined. For example, pattern matching engine 120 may determine whether an application is associated with the matched pattern 122. For example, pattern matching engine 120 may determine that application 110A of applications 110A-110M, a service associated with application 112A or data associated with application 112 may be associated with pattern 122.

At operation 508, an application package is provided to client device. For example, application package 214 that may include application 110A, a service associated with application 110A or an action associated with application 110A may be provided to client device 104. As discussed above, once application package 214 is provided to client device 104, application 110A, the service provided by application 110A or an action provided by application 110A may be included in application 112.

As also discussed above, method 500 may repeat at continuous time intervals. In this way, application 112 continuously receives applications 110A-110M, actions, and services from platform 108.

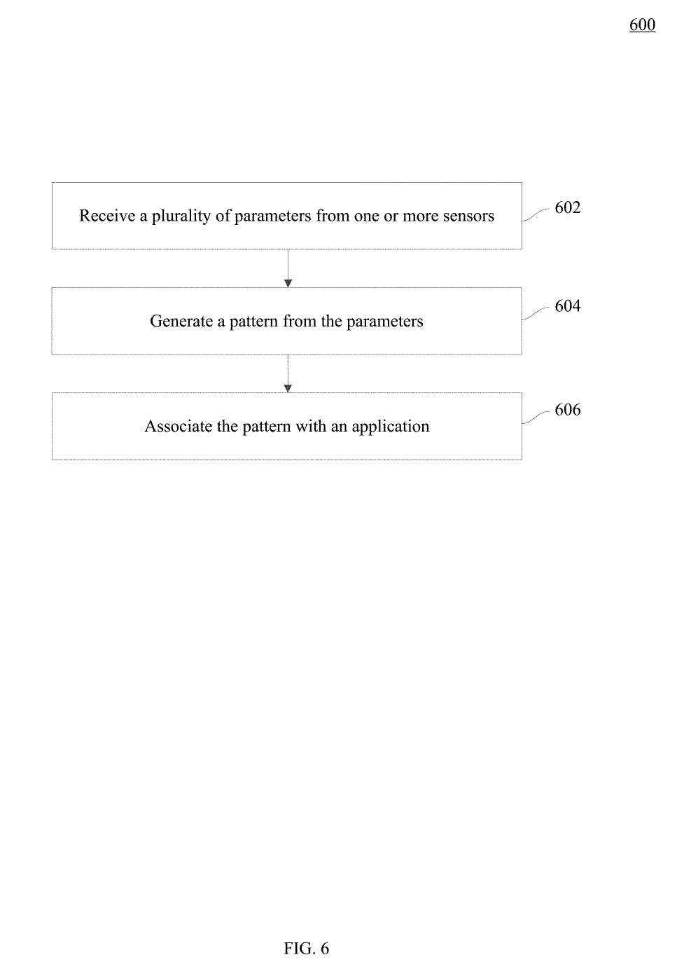

FIG. 6 is a flowchart of a method 600 for configuring a pattern for an application, according to an embodiment. Method 600 may be performed using hardware and/or software components described herein and in, e.g., FIGS. 1-3. Notably, one or more of the operations may be deleted, combined, or performed in a different order as appropriate. Further, additional operations may be performed at various stages of the method.

At operation 602, parameters are received. For example, sensors 206 may obtain parameters 208 from client device 104. Example parameters 208 may include location information, such as signal strengths from various signal sources, user information, weather information, date and time information, etc.

At operation 604, a pattern is generated. For example, pattern configuration interface 126 may use one or more parameters 208 to generate pattern 122 or transmit one or more parameters to pattern generator 118 to generate pattern 122. As part of the generating pattern 122, pattern configuration interface 126 or pattern generator 118 may determine a range of value for parameters in pattern 122 and/or rules for parameters 208 in pattern 122.

At operation 606, an application is associated with the pattern. For example, pattern generator 118 may associate one or more applications 110A-110M, services provided by one or more applications 110A-110M and/or actions provided with one or more applications 110A-110M with pattern 122.

In accordance with various embodiments of the disclosure, computer system 700, such as a computer and/or a server, includes a bus 702 or other communication mechanism for communicating information, which interconnects subsystems and components, such as a processing component 704 (e.g., processor, micro-controller, digital signal processor (DSP), graphics processing unit (GPU), etc.), a system memory component 706 (e.g., RAM), a static storage component 708 (e.g., ROM), a disk drive component 710 (e.g., magnetic or optical), a network interface component 712 (e.g., modem or Ethernet card), a display component or a display screen 714 (e.g., CRT or LCD), an input component 718 (e.g., keyboard, keypad, or virtual keyboard), a cursor control component 720 (e.g., mouse, pointer, or trackball), a location determination component 722 (e.g., a Global Positioning System (GPS) device as illustrated, a cell tower triangulation device, and/or a variety of other location determination devices known in the art), and/or a camera component 723. In one implementation, the disk drive component 710 may include a database having one or more disk drive components.

In accordance with embodiments of the disclosure, the computer system 700 performs specific operations by the processor 704 executing one or more sequences of instructions contained in the memory component 706, such as described herein with respect to the mobile communications devices, mobile devices, and/or servers. Such instructions may be read into the system memory component 706 from another computer readable medium, such as the static storage component 708 or the disk drive component 710. In other embodiments, hard-wired circuitry may be used in place of or in combination with software instructions to implement the disclosure.

Logic may be encoded in a computer readable medium, which may refer to any medium that participates in providing instructions to the processor 704 for execution. Such a medium may take many forms, including but not limited to, non-volatile media, volatile media, and transmission media. In one embodiment, the computer readable medium is non-transitory. In various implementations, non-volatile media includes optical or magnetic disks, such as the disk drive component 710, volatile media includes dynamic memory, such as the system memory component 706, and transmission media includes coaxial cables, copper wire, and fiber optics, including wires that include the bus 702. In one example, transmission media may take the form of acoustic or light waves, such as those generated during radio wave and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read. In one embodiment, the computer readable media is non-transitory.

In various embodiments of the disclosure, execution of instruction sequences to practice the disclosure may be performed by the computer system 700. In various other embodiments of the disclosure, a plurality of the computer systems 700 coupled by a communication link 724 to the network 102 (e.g., such as a LAN, WLAN, PTSN, and/or various other wired or wireless networks, including telecommunications, mobile, and cellular phone networks) may perform instruction sequences to practice the disclosure in coordination with one another.

The computer system 700 may transmit and receive messages, data, information and instructions, including one or more programs (i.e., application code) through the communication link 724 and the network interface component 712. The network interface component 712 may include an antenna, either separate or integrated, to enable transmission and reception via the communication link 724. Received program code may be executed by processor 704 as received and/or stored in disk drive component 710 or some other non-volatile storage component for execution.

Where applicable, various embodiments provided by the disclosure may be implemented using hardware, software, or combinations of hardware and software. Also, where applicable, the various hardware components and/or software components set forth herein may be combined into composite components including software, hardware, and/or both without departing from the scope of the disclosure. Where applicable, the various hardware components and/or software components set forth herein may be separated into sub-components including software, hardware, or both without departing from the scope of the disclosure. In addition, where applicable, it is contemplated that software components may be implemented as hardware components and vice-versa.

Software, in accordance with the disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein. The foregoing disclosure is not intended to limit the disclosure to the precise forms or particular fields of use disclosed. As such, it is contemplated that various alternate embodiments and/or modifications to the disclosure, whether explicitly described or implied herein, are possible in light of the disclosure. Having thus described embodiments of the disclosure, persons of ordinary skill in the art will recognize that changes may be made in form and detail without departing from the scope of the disclosure. One of ordinary skill in the art should also realize that such equivalent constructions do not depart from the spirit and scope of the present disclosure, and that they may make various changes, substitutions and alterations herein without departing from the spirit and scope of the present disclosure.

What is claimed is:

1. A system, which comprises:
one or more non-transitory computer-readable memories storing instructions; and
one or more hardware processors coupled to each of the non-transitory computer-readable memories and adapted to customize content, the instructions that, when executed, comprise:
receiving a pattern from a client device, wherein the pattern includes a plurality of parameters identified using the client device;
retrieving a plurality of patterns associated with a plurality of applications included in a platform that is communicatively coupled to the client device;
determining a match between the plurality of parameters in the pattern received from the client device and a pattern from the plurality of patterns;
determining a first application in the plurality of applications that is associated with the matched pattern in the plurality of patterns;
generating an application package that includes instructions for manipulating an application executing on the client device using the first application; and
providing the application package to the client device, wherein instructions in the application package manipulate the application executing on the client device.

2. The system of claim 1, wherein the instructions further comprise:
receiving a second pattern from the client device within a preconfigured time interval from the pattern received from the client device, wherein at least one parameter in the second pattern is different from the plurality of parameters in the first pattern;
determining a match between the second pattern and a second pattern in the plurality of patterns;
determining that the first application in the plurality of applications is associated with the second pattern in the plurality of patterns;
generating a second application package that includes instructions for manipulating the application executing on the client device according to the first application; and
providing the second application package to the client device, wherein instructions in the second application package manipulate the application executing on the client device.

3. The system of claim 1, wherein the instructions further comprise:
receiving a second pattern from the client device that is different from the first pattern;
determining a match between the second pattern and a second pattern in the plurality of patterns;
determining that a second application in the plurality of applications is associated with the second pattern in the plurality of patterns;
generating a second application package that includes instructions for manipulating the application executing on the client device according to the second application; and
providing the application package to the client device, wherein instructions in the second application package manipulate the application executing on the client device.

4. The system of claim 1, wherein a first pattern includes a first parameter associated with a location of the client device and a second parameter that is associated with user information.

5. The system of claim 1, wherein a first pattern includes a first parameter associated with user information and a second pattern is associated with weather.

6. The system of claim 1, wherein the instructions further comprise:
generating a second application package that includes instructions for manipulating a second application executing on a second client device using the first application from the plurality of applications executing on the platform; and
providing the second application package to a second client device, wherein instructions in the second application package manipulate an application executing on the second client device.

7. The system of claim 1, wherein the instructions in the application package include a service that executes on the application executing on the client device.

8. The system of claim 1, wherein the instructions further comprise:
providing a first parameter and a second parameter;
generating a second pattern in the plurality of patterns using the first parameter and the second parameter, wherein the generating identifies a range of values that includes a value in the first parameter; and
associating the second pattern in the plurality of patterns with a second application in the plurality of applications.

9. A method for configuring a platform, which method comprises:
receiving a first pattern from a client device, wherein the first pattern includes a plurality of parameters and wherein the first parameter in the plurality of patterns is associated with location of the client device and a second parameter in the plurality of patterns is associated with user information stored in an application that executed on the client device;
retrieving a plurality of patterns associated with a plurality of applications included in a platform that is communicatively coupled to the client device;
determining a match between the plurality of parameters in the pattern received from the client device and a pattern from the plurality of patterns;
determining a first application in the plurality of applications that is associated with the pattern in the plurality of patterns;
generating an application package that includes instructions for manipulating the application executing on the client device using the first application; and
providing the application package to the client device, wherein instructions in the application package manipulate the application executing on the client device.

10. The method of claim 9, further comprising:
receiving a second pattern from the client device within a preconfigured time interval from the pattern received from the client device;
determining a match between the second pattern and a second pattern in the plurality of patterns;
determining that the first application in the plurality of applications is associated with the second pattern in the plurality of patterns;
generating a second application package that includes instructions for manipulating the application executing on the client device according to the first application; and
providing the second application package to the client device, wherein instructions in the second application package manipulate the application executing on the client device.

11. The method of claim 9, further comprising:
receiving a second pattern from the client device that is different from the first pattern;
determining a match between the second pattern received from the client device and a second pattern in the plurality of patterns;
determining that a second application in the plurality of applications is associated with the second pattern in the plurality of patterns;
generating a second application package that includes instructions for manipulating the application executing on the client device according to the second application; and
providing the application package to the client device, wherein instructions in the second application package manipulate the application executing on the client device.

12. The method of claim 9, wherein the application package includes a notification to be displayed using the application executing on the client device.

13. The method of claim 9, wherein a first pattern includes a pattern associated with user information and a second pattern is associated with weather.

14. The method of claim 9, further comprising:
generating a second application package that includes instructions for manipulating a second application executing on a second client device using the first application from the plurality of applications executing on the platform; and
providing the second application package to a second client device, wherein instructions in the second application package manipulate an application executing on the second client device.

15. The method of claim 9, wherein the instructions in the application package instantiate the first application on the client device.

16. The method of claim 9, further comprising:
providing a first parameter and a second parameter;
generating a second pattern in the plurality of patterns using the first parameter and the second parameter, wherein the generating identifies a range of values that includes a value in the first parameter; and
associating the second pattern in the plurality of patterns with a second application in the plurality of applications.

17. A non-transitory machine-readable medium having stored thereon instructions for performing a method that customizes content, the method, when executed by at least one machine, causes the machine to:
receive a pattern from a client device, wherein the pattern includes a plurality of parameters including a first parameter and a second parameter of a type different from the first parameter;
retrieve a plurality of patterns associated with a plurality of applications included in a platform that is communicatively coupled to the client device;
determine a match between the pattern received from the client device and a pattern from the plurality of patterns, wherein the first parameter is matched against a value range in the plurality of parameters;
determine a first application in the plurality of applications that is associated with the pattern in the plurality of patterns;
generate an application package that includes instructions for manipulating an application executing on the client device using the first application; and
provide the application package to the client device, wherein instructions in the application package manipulate the application executing on the client device.

18. The non-transitory machine-readable medium of claim 17, wherein the instructions further cause the machine to:
receive a second pattern from the client device within a preconfigured time interval from the pattern received from the client device;
determine a match between the second pattern and a second pattern in the plurality of patterns;
determine that the first application in the plurality of applications is associated with the second pattern in the plurality of patterns;
generate a second application package that includes instructions for manipulating the application executing on the client device according to the first application; and
provide the second application package to the client device, wherein instructions in the second application package manipulate the application executing on the client device.

19. The non-transitory machine-readable medium of claim 17, wherein a first pattern includes a first parameter associated with a location of the client device and a second parameter that is associated with user information.

20. The non-transitory machine-readable medium of claim 17, wherein the instructions further cause the machine to:
provide a first parameter and a second parameter;
generate a second pattern in the plurality of patterns using the first parameter and the second parameter, wherein the generating identifies a range of values that includes a value in the first parameter; and
associate the second pattern in the plurality of patterns with a second application in the plurality of applications.
